(19) United States
(12) Patent Application Publication
(10) Pub. No.: US 2003/0035755 A1
(43) Pub. Date: Feb. 20, 2003

(54) Organic electroluminescence (OEL)-based biochips

(76) Inventors: Shu-Hui Chen, Tainan City (TW); Chung-Shi Yang, Taichung City (TW); Si-Chung Chang, Hsinchu City (TW); Chun-Che Lin, Yung-Kang City (TW); Shih-Yao Sun, Hsin-Ying City (TW)

Correspondence Address: FISH & RICHARDSON PC, 225 FRANKLIN ST, BOSTON, MA, 02110, US

(21) Appl. No.: 09/931,447

(22) Filed: Aug. 16, 2001

(51) Int. Cl. G01N 21/76

(52) U.S. Cl. 422/52; 422/82.05; 422/82.08; 422/82.09; 436/164; 436/165; 436/172; 436/805; 436/800

(57) ABSTRACT

Organic electroluminescent (OEL) devices are proposed herein to be fabricated either as a light source or a heating source for biochips. Under the proposed approach, an OEL-emitting member is fabricated as the substrate of the biochip on which the biological samples, such as DNA, proteins and other related small molecules, are processed for the desired applications, including but not limited to, analysis of biological molecules, such as electrophoretic separation, PCR amplification and hybridization.

### BACKGROUND OF THE INVENTION

1) Field of the Invention

This invention relates to an organic electroluminescence (OEL)-based biochip, comprising a biochip adapted to perform a predetermined bioassay for DNAs, proteins or cells, or drug screening, cell-based assays, etc., and an OEL-emitting member fabricated as the substrate of the biochip and acting as a light source or a heating source for the biochip.

2) Description of the Related Art

In recent years, methods of isolating arrays of biomolecules on various supports, referred to as biochips, have been developed and employed in DNA synthesis, sequencing, mutation studies, gene expression analysis and gene discovery. In particular, efforts have been made to produce chips upon which biological molecules such as protein or DNA are immobilized in predetermined arrays. Patterning such molecules on semiconductor substrates, coupled with specific recognition, are essential for the realization of bio-molecular networks. Generally, the biochips are micro matrices (i.e., micro arrays) of molecules bound to a substrate, either directly or through a linking group or, more recently, by way of a gel layer. Furthermore, addressable arrays of DNA (Fodor, S. P. A., Read, J. L., Pirrung, M. C., Stryer, L., Lu, A. T., and Solas, D. Science 251:767 (1991); and Southern, E. M. Trends in Genetics 12:110 (1996) both of which are hereby incorporated by reference in their entirety) or proteins immobilized on a substrate can be used to provide tools for information retrieval, hybridization of DNA and binding affinity for molecules, such as proteins, antibodies, lipids or carbohydrates, in a quick and reliable manner.

Most biochips are designed to facilitate synthesis of biomolecules at known locations on a substrate. For example, one such biochip employs light and a series of photo-lithographic masks to activate specific sites on a substrate, such as glass or plastic, in order to selectively bind nucleic acids thereto and, subsequently, to attach additional nucleic acids to form known oligonucleotides at the desired locations. This process of using light and photolithographic masks to activate specific sites on a substrate is similar to the processes used in production of the microelectronic semiconductor chip. The manufacture of such chips borrows substantially from photolithographic microfabrication techniques developed and optimized by the computer microprocessor industry, which permit the economical production of large batches of chips using photolithographic templates.

At the present time, most of the available optical detection systems for bio-analysis are in the form of expensive and bulky instruments, such as the fluorescent microscope. As the technique advances to miniaturized and high-throughput devices, detection systems will need to be modified towards a portable and sensor-type detection. Although M. A. Burns et al. (Science, October 1998, Vol. 282, pp. 484-487) has previously reported an integrated Naloliter DNA analysis device using an external blue light-emitting diode (LED) as the excitation source for microchips, such a lighting system may not be suitable for use in biochips of multi channels or arrays since the LED merely functions as a spot light source.

Accordingly, there still exists a need to develop new biochip systems which can be more economically manufactured and examined by use of ordinary optical detection equipments commonly employed in laboratories.

In 1987, Kodak-USA successfully developed an electroluminescent device by applying low voltage on a small molecule (Applied Physics letter, Volume 51, pp. 914, 1987). In 1990, the Cambridge University further developed an electro-luminescent device by using polymer as the light-emitting layer (Nature, Volume 347, pp. 539, 1990), and that has improved the practicality of the electro-luminescent device. Since then, numerous academic and industrial research studies based on electro-luminescent devices have been established.

Organic electroluminescent (OEL) devices has become popular in recent years for their potential applications in large-area, flat-panel, and high-luminance full-color displays, utilizing low driving voltage, either as backlighting sources or directly as emitters in emissive displays. Nevertheless, the use of OEL as the excitation source for bioanalytical application has not been proposed until now.

### SUMMARY OF THE INVENTION

Accordingly, in this invention, organic electroluminescent (OEL) devices are proposed to be fabricated either as a light source or a heating source for biochips. Under the proposed approach, an OEL-emitting member is fabricated as the substrate of the biochip on which the biological samples, such as DNA, proteins and other related small molecules, are processed for the desired applications, including but not limited to, analysis of biological molecules, such as electrophoretic separation, PCR amplification and hybridization.

In a first embodiment, the present invention provides an organic electroluminescence (OEL)-based biochip, comprising:

a sheet member incorporating an OEL layer, and

a microchip component mounted on one side of the sheet member to perform a predetermined application which is selected from a group that includes gene expression analysis, protein immunoassays, drug screening and cell-based assays and which optionally involves a biological system,

the OEL layer acting as one of a light source and a heating source for the microchip component, or inducing photocurrent generated from an electrochemical reaction occurring in the biological system involved in the application of the first microchip component.

Preferably, the sheet member and the microchip component are integrally microfabricated to form a one-piece device.

Preferably, the sheet member is fabricated such that the OEL layer is formed on a flexible substrate.

In an alternative embodiment, the sheet member is fabricated into a transparent OLED (TOLED) component that permits OEL emission from each side thereof, and a microchip component can be mounted on the surface of each side of the sheet member.

Preferably, the OEL-based biochip further comprises means superposed on the first microchip component for spectrally collecting fluorescence signal or transparent light emitted from the OEL layer and passing through the microchip component. The spectral collecting means can be manufactured as a separate component or, preferably, may be integrally microfabricated on top of the first microchip component. Preferably, the spectral collecting means comprises a photosensor for collecting the filtered, emitted fluorescence signal or transparent light. Preferably, the photosensor is a photomultiplier tube (PMT) or a photodiode or a charge-coupled device (CCD). Preferably, the photosensor is connected to a computer for data processing and display.

Preferably, the OEL-based biochip further comprises means positioned between the microchip component and the collecting means for spectrally filtering fluorescence signal or transparent light emitted from the OEL layer and passing through the microchip component. Preferably, the filtering means may comprise an optical lens for filtering the fluorescence signal or transparent light emitted from the OEL layer and passing through the first microchip component.

Depending on the nature of the light source and the property of the analyte to be detected, the aforesaid design of the OEL-based biochip is applicable for the detection of the absorbed light or fluorescence by the analyte.

In a further embodiment, the present invention provides an organic electroluminescence (OEL)-based biochip, comprising:

(a) a sheet member incorporating an OEL layer; and

(b) a composite laminate mounted on one side of the sheet member and comprising in series the following elements superposed one upon the other:

(1) first filtering means for filtering fluorescence signal or transparent light excited from the OEL layer;

(2) a ball lens and a pinhole layer for focusing the filtered, excited fluorescence signal or transparent light;

(3) a microchip component to perform a predetermined application which is selected from a group that includes gene expression analysis, protein immunoassays, drug screening and cell-based assays and which optionally involves a biological system;

(4) second filtering means superposed on the microchip component for filtering the fluorescence signal or transparent light emitted from the microchip component; and

(5) a photosensor for collecting the filtered, emitted fluorescence signal or transparent light;

the OEL layer acting as one of a light source and a heating source for the microchip component, or inducing photocurrent generated from an electrochemical reaction occurring in the biological system involved in the application of the microchip component.

If the sheet member of this embodiment is fabricated into a transparent OLED component, a second composite laminate with the same construction as that of the first composite laminate can be mounted on the other side of the sheet member.

Preferably, the photosensor is a PMT or a photodiode or a charge-coupled device (CCD). Preferably, the photosensor is connected to a computer for data processing and display.

Preferably, the aforesaid structural components of the OEL-based biochip are integrally microfabricated.

### BRIEF DESCRIPTION OF THE DRAWINGS

The above and other objects and features of the present invention will become better understood with reference to the following descriptions, appended claims, and accompanying drawings of which:

FIG. 1 shows the detection operation of a first embodiment using an optical microscope;

FIGS. 2A and 2B shows the OEL emission behavior of two fluorescence dyes;

FIG. 3 shows the fluorescence emission phenomenon of Fluorescent microsphere excited by the OEL emission from the OEL layer acting as the light source;

FIGS. 4A and 4B shows the fluorescence stability of Fluorescent microsphere using the first embodiment;

FIG. 5 shows a second embodiment of the present invention; and

FIG. 6 shows a third embodiment of the present invention.

### DETAILED DESCRIPTION OF THIS INVENTION

The use of OEL emission as the light source or heating source for biochip applications should be logically advantageous because the flat format of an OEL-emitting member is comparable with biochips and more importantly, the fabrication process of an OEL-emitting member can be easily adopted into the fabrication process for biochips. In addition, an OEL-emitting member has a greater flexibility such as a rollable substrate which enables the use of cheaper and disposable polymer material. Once the platform manufacturing technique for OEL-based biochips is developed, many biological assays can be applied as a disposable diagnostic kit.

When using OEL emission as a light source, the lighting region is lithographically fabricated in defined areas of the substrate of an OEL-emitting member. Preferably, the OEL emission is directed to the sample disposed above through an optical lens which is fabricated as an integrated unit on the surface of the substrate for focusing. The fluorescence signal or transparent light is then spectrally filtered and collected by photodiodes which are either placed on top of the OEL-based biochip as a separate device or microfabricated on top of the OEL-based biochip as an integral part.

When using OEL emission as a heating source, the OEL emission in the near IR region is utilized to generate the required heat for biochemical reactions, such as PCR or enzymatic digestions.

In addition to the aforesaid, the OEL emission can also be used to induce photocurrent generated from a specific electrochemical reaction occurring in a biological system. For example, there have been developed various types of microphysiometers suitable for use in the detection of measurands detected by the current measurement (McConnel, H. M., Owicki, J. C., Parce, J. W., Miller, D. L., Baxter, G. T., Wada, J. G. and Pitchford, S. (1992), Science, 257:1906-1912; Adami, M., Piras, L., Lanzi, M., Fanigliulo, A., Vakula, S. and Nicoini, C. (1994), Sens. Actuators (B) 18:178-182; Baxter, G. T., Bousse, L. J., Dawes, T. D., Libby, J. M., Modlin, D. N., Owicki, J. C. and Parce, J. W. (1994), Clin. Chem., 40:1800-1804; Adami, M., Sartore, M. and Nicolini, C. (1995), Biosens. Bioelec., 10:155-167; Adami, M., Sartore, M. and Nicolini, C. (1995), Biosens. Bioelec., 10:633-638; K. R. Rogers et al., Anal. Biochem. (1992), Vol. 202, pp. 111-116; and D. Hafeman et al., Science (1998) Vol. 240, pp. 1182-1185).

The microphysiometer is designed for detection of net changes in proton concentration as a result of cellular process, such as phosphorylation, diffusion and ion pumping. When the OEL-based biochip according to this invention is used in the detection of a specific biochemical reaction occurring in an immobilized biological preparation, the OEL emission will not interfere with the electrical signal induced thereby.

According to this invention, there is provided an OEL-based biochip, comprising an OEL-emitting member fabricated as the substrate of the biochip and acting as a light source or a heating source for the biochip; and a microchip component superposed on the OEL-emitting member and adapted to perform a predetermined application, such as gene expression analysis, protein immunoassays, drug screening, cell-based assays, etc.

Preferably, the OEL-emitting member and the microchip component are integrally microfabricated to form a one-piece device.

Preferably, the OEL-based biochip is microfabricated in a dimension ranging from 20 mm to 10 cm in length, from 20 mm to 10 cm in width and from 0.5 mm to 4 mm in height. For example, if the OEL-based biochip is manufactured in the form of a microarray chip, it may be microfabricated with dimensions having several hundred micrometers to several millimeters. As for a microfluidized chip, the OEL-based biochip may be microfabricated with dimensions having several centimeters. In a preferred embodiment, the OEL-based biochip is manufactured with a dimension of 30 mm×30 mm×0.6 mm.

The OEL-emitting member may be fabricated by techniques commonly employed in the manufacture of OEL display elements. To this end, available references include but are not limited to, C. W. Tang and S. A. Vanslyke, Appl. Phys. Lett., July 1987, 51 (12): 913-915; Chemistry (The Chinese Chem. Soc., Taipei) March 1996 54 (1), pp. 125-145; Andrei A. Shoustikov et al., IEEE Journal of Selected Topics in Quantum Electronics, Vol. 4, No. 1, January/February, 1998, pp. 3-13; M. G. Mason et al., J. Appl. Physics, Vol. 86, No. 3, August 1999, pp. 1688-1692; Junji Kido and Yasuhiro Iizumi, Appl. Phys. Lett., 9 November 1998, Vol. 73, No. 19, pp. 2721-2723; G. Gu and Stephen R. Forrest, IEEE Journal of Selected Topics in Quantum Electronics, Vol. 4, No. 1, January/February, 1998, pp. 83-99; and L. S. Hung et al., Appl. Phys. Lett. January 1997, 70 (2): 152-154.

The OEL-emitting member may be made with a thickness in the range of from 0.35 mm to 0.75 mm, and preferably 0.5 mm.

Preferably, the OEL-emitting member is manufactured on a flexible substrate, such as plastic substrate. Preferably, the OEL-emitting member is fabricated as a transparent OLED (TOLED) component that permits OEL emission form the top and bottom sides thereof. In these aspects, available references include but are not limited to, Ye He and Jerzy Kanichi, Appl. Phys. Lett., Feb. 7, 2000, 76 (6): 661-663; and P. E. Burrows et al., “A Bright, Transparent, Blue Organic Light Emitting Device,” Author Affiliation: Princeton University, Source: Annual Device Research Conference Digest, Jun. 24-26 1996, IEEE pp. 146-147.

The OEL-emitting member may be fabricated to incorporate an OEL layer composed of suitable organic electroluminent materials so that the OEL layer emits an OEL emission selected from an emission of green luminescent wavelength preferably in the range of 500-550 nm, an emission of red luminescent wavelength preferably in the range of 590-640 nm, an emission of blue luminescent wavelength preferably in the range of 435-485 nm, and a full color emission. For example, the OEL-emitting member can be fabricated according to C. W. Tang and S. A. Vanslyke, July, 1987, Appl. Phys. Lett., 51: 913-915, so that it is able to provide an OEL emission of green luminescence wavelength.

The microchip component may be immobilized with biological molecules, such as DNA, RNA, proteins, lipids, carbohydrates or hormones, onto a substrate, such as glass, silica, quartz, acrylic, and polymeric materials such as polycarbonate (PC), polyethylene tetraphthalate glycol (PETG) or hydrophilic poly(methyl methacrlate) (PMMA) and the like, and has applications in bioelectronic, DNA hybridization assays, drug assays, etc.

According to this invention, the microchip component may be manufactured in the form of an array type device or a microfluidic system.

Patents and published patent applications describing arrays of biopolymeric compounds and methods for their fabrication include: U.S. Pat. Nos. 5,242,974; 5,384,261; 5,405,783; 5,412,087; 5,424,186; 5,429,807; 5,436,327; 5,445,934; 5,472,672; 5,527,681; 5,529,756; 5,545,531; 5,554,501; 5,556,752; 5,561,071; 5,599,895; 5,624,711; 5,639,603; 5,658,734; WO 93/17126; WO 95/11995; WO 95/35505; EP 742 287; and EP 799 897.

Patents and published patent application describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; WO 95/21265; WO 96/31622; WO 97/10365; WO 97/27317; EP 373 203; and EP 785 280.

Other references providing a review of micro array technology, including formats for arrays and methods of their use include: Lockhart et al., Nature Biotechnology (December 1996) 14: 1675. Clontech Catalogue, 97/98, (Clontech Laboratories, Inc. 1020 East Meadow Circle, Palo Alto Calif. 94303) p. 81 describes premade Northern blots.

For the microchip component in the form a microfluidic system, reference is made to Chen Y H, Chen S H, Analysis of DNA fragments by microchip electrphoresis fabricated on PMMA substrates using wire-imprinting method, Electrophoresis, 2000, Vol. 21, issue 1, pp. 165-170 and the relevant references cited therein.

The microchip component may be made with a thickness in the range of from 0.5 mm to 4.6 mm, and preferably 0.5 mm.

The analysis that is conducted on the microchip component may be detected by a dye tagged to the reacted biological molecules present on the microchip component.

To ensure the detection sensitivity, the dye preferably can be excited by absorbing the OEL emission from the OEL layer such that upon use, the dye generates a detectable emission wavelength, the peak of which is sufficiently apart from the peak of the excitation wavelength of the dye and the peak of the OEL emission.

Preferably, the peak of excitation wavelength and the peak of emission wavelength of the dye are apart from each other by at least 25 nm. Preferably, the peak of excitation wavelength of the dye is around 525±25 nm.

When the OEL layer emits an OEL emission of green luminescent wavelength preferably in the range of 500-550 nm, suitable dyes for use in this invention include but are not limited to, TransFluoSpheres® carboxylate-modified microspheres (purchased from Molecular Probes, Inc.), 7-aminoactinomycin D (7-ADD), Nile Red, and Propidium Iodine. Each of these dyes has a peak of emission wavelength near 525 nm. While having a peak of emission wavelength different from that of the other, these dyes share a common feature, i.e. the peak of excitation wavelength and the peak of emission wavelength thereof are far apart from each other. Depending on the selected dye, the obtained signal strength may vary.

When the OEL layer emits an OEL emission of red luminescent wavelength preferably in the range of 590-640 nm, suitable dyes for use in this invention include but are not limited to, Naphthofluorescein, 5- and 6-carboxynaphthofluoresceins, succinimidyl ester mixed siomers and transfluospheres fluorescent microspheres.

When the OEL layer emits an OEL emission of blue luminescent wavelength preferably in the range of 435-485 nm, suitable dyes for use in this invention include but are not limited to, NBD, 3-(4-carboxybenzoyl)quinoine-2-carboxaldehyde (CBQCA), 6-(N-(7-nitrobenz-2-oxa-1,3-diazol-4-yl)amino)hexanoic acid, naphthalene-2,3-dicarboxaldehyde (NDA), succinimidyl 6-(N-(7-nitrobenz-2-oxa-1,3-diazo-4-yl)amino)hexanote (NBD-X, SE) and ethidium monoazide bormide. All of theses dyes can be purchased from Molecules Probes, Inc. (see “Handbook of Fluorescent Probes and Research Chemicals” edited by Richard P. Haugland, sixth edition, 1996).

Preferably, the OEL-based biochip further comprises means superposed on the microchip component for spectrally collecting fluorescence signal or transparent light emitted from the OEL layer and passing through the microchip component.

The collecting means can be manufactured as a separate component or may be integrally microfabricated on top of the microchip component. Preferably, the collecting means comprises a photosensor for collecting the filtered, emitted fluorescence signal or transparent light. Preferably, the photosensor is a photomultiplier (PMT) or a photodiode or a charge-coupled device (CCD). Preferably, the photosensor is connected to a computer for data processing and display.

Preferably, the OEL-based biochip further comprises first filtering means positioned between the microchip component and the collecting means for spectrally filtering fluorescence signal or transparent light emitted from the OEL layer and passing through the microchip component.

Preferably, the first filtering means is an emission filter. Commercially availably emission filters include those available from Optosigma Corporation.

Alternatively, the first filtering means may be positioned on the microchip component by forming a filter coating on the microchip component by a conventional methodology selected from plating, sputtering, E-beam and thermal evaporation, to a predetermined thickness, e.g. in the range of from 100 Å to 1000 Å, and preferably 500 Å.

To enhance the filtering effect, the first filtering means may comprise a pinhole layer and an emission filter superposed on the pinhole layer.

Preferably, the OEL-based biochip further comprises second filtering means positioned between the OEL-emitting member and the microchip component for spectrally filtering fluorescence signal or transparent light emitted from the OEL layer.

Preferably, the second filtering means is an excitation filter. Commercially availably excitation filters include those available from Optosigma Corporation.

Alternatively, the second filtering means may be formed on the OEL layer by forming a filter coating on the OEL layer by conventional plating, sputtering, E-beam, thermal evaporation methodologies to a predetermined thickness, e.g. in the range of from 100 Å to 1000 Å, and preferably 500 Å.

To enhance the detection sensitivity of the OEL-based microchip, a ball lens and a pinhole layer may be positioned between the second filtering means and the microchip component for focusing the fluorescence signal or transparent light emitted from the OEL layer and passing through the second filtering means.

In an alternative embodiment of this invention, the OEL-based microchip comprises an OEL-emitting member which is fabricated into a transparent OLED component, each side of which is mounted with a composite laminate comprising in series the following elements superposed one upon the other: (1) first filtering means for filtering fluorescence signal or transparent light excited from the OEL layer; (2) a ball lens and a pinhole layer for focusing the filtered, excited fluorescence signal or transparent light; (3) a microchip component to perform a predetermined application which is selected from a group that includes gene expression analysis, protein immunoassays, drug screening and cell-based assays and which optionally involves a biological system; (4) second filtering means superposed on the microchip component for filtering the fluorescence signal or transparent light emitted from the microchip component; and (5) a photosensor for collecting the filtered, emitted fluorescence signal or transparent light.

Preferably, the photosensor is one of a PMT, a photodiode and a charge-coupled device (CCD), and it may be connected to a computer for data processing and display.

Preferred Embodiments for Practicing the Invention

The following Examples are given for the purpose of illustration only and are not intended to limit the scope of the present invention.

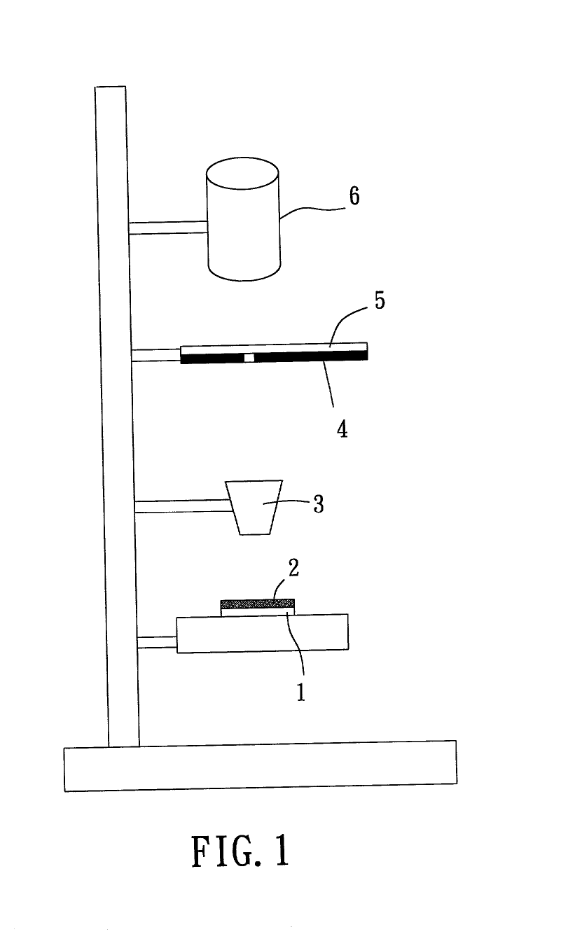

Referring to FIG. 1, a first embodiment according to this invention is provided on the stage of an optical microscope (OLYMPUS BX40) for detection. The first embodiment is composed of an OEL-emitting member 1 and a microchip component 2 superposed on the OEL-emitting member 1.

The OEL-emitting member 1 is fabricated according to C. W. Tang and S. A. Vanslyke, July, 1987, Appl. Phys. Lett., 51: 913-915, so that an OEL layer capable of providing an OEL emission with a peak of 525 nm is incorporated therein. Concerning the shift of the peak of OEL emission from 550 nm to 525 nm, this may probably be due to the purity of the employed materials and the thickness of the OEL layer thus formed.

The microchip component 2 is fabricated on a poly(methyl methacrlate) (PMMA) substrate according to Chen Y H, Chen S H, Electrophoresis, 2000, Vol. 21, issue 1, pp. 165-170.

The first embodiment is contrasted in a dimension of 350 mm×450 mm×600 mm, and the OEL-emitting member 1 and the microchip component 2 are made with a thickness of 0.6 mm and 2.0 mm, respectively.

An objective lens 3, a pinhole layer 4 and an emission filter 5, and a photosensor 6 are sequentially disposed above the OEL-based biochip. For detection, the fluorescence signal or transparent light emitted from the OEL-emitting member 1 passes through the microchip component 2, the objective lens 3, and the pinhole layer 4 and the emission filter 5 to reach the photosensor 6, which can be connected to a computer for data processing and display (not shown).

To ensure the detection sensitivity of the OEL-based biochip according to this invention, it is preferred that a dye which is selected for tagging onto the reacted biological molecules present on the microchip component, in particular the biological molecules immobilized on the microchip component for reacting with a desired analyte in a sample, can be excited by absorbing the OEL emission from the OEL layer such that upon use, the dye generates a detectable emission wavelength, the peak of which is sufficiently apart from the peak of the excitation wavelength of the dye and the peak of the OEL emission.

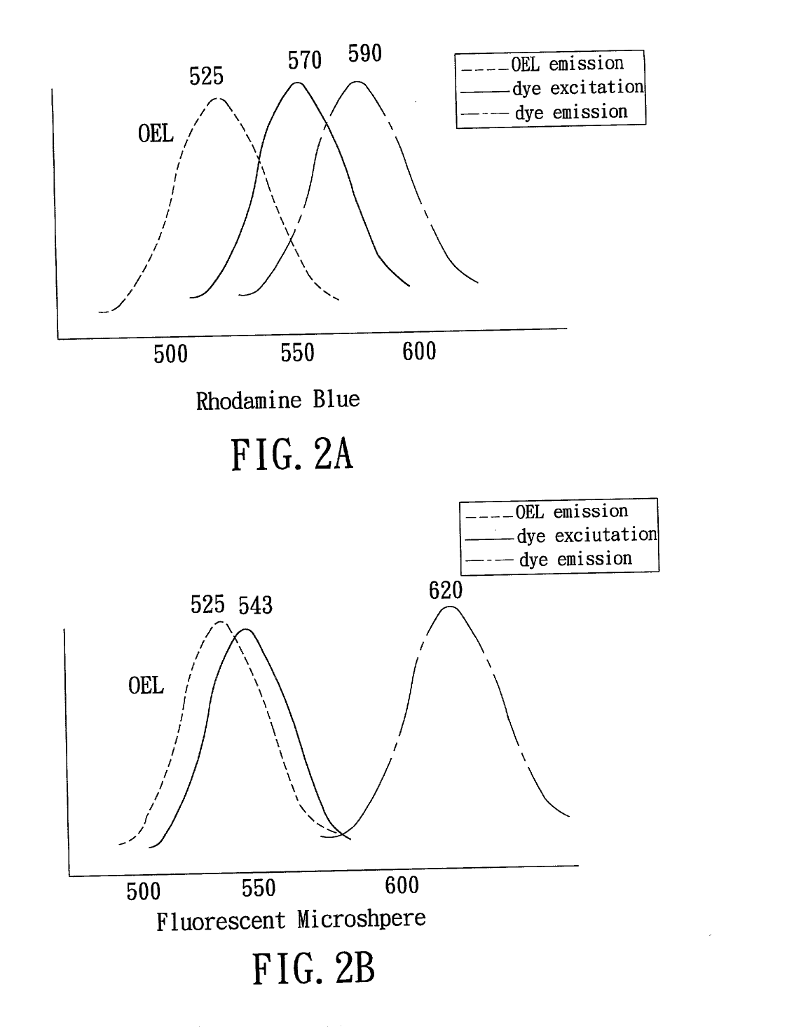

To achieve this, two different dyes, Rhodamine Blue (purchased from Riedel-deHaën) and Fluorescent Microsphere (TransFluoSpheres® carboxylate-modified microspheres, purchased from Molecular Probes, Inc.), are tested for their excitation and emission behaviors. As can be seen from the results shown in FIG. 2B, the peak of excitation wavelength of Fluorescent Microsphere departs from its peak of emission wavelength by more than 25 nm. As compared with Rhodamine Blue (FIG. 2A), the excitation and emission wavelength curves of Fluorescent Microsphere do not interfere with the OEL emission curve from the OEL layer.

Accordingly, Fluorescent Microsphere is suitable for use as the tagging label for the microchip component, and it is selected for conducting further experiments. Other dyes having similar excitation and emission features include, but are not limited to, 7-aminoactinomycin D (7-ADD), Nile Red or Propidium Iodine.

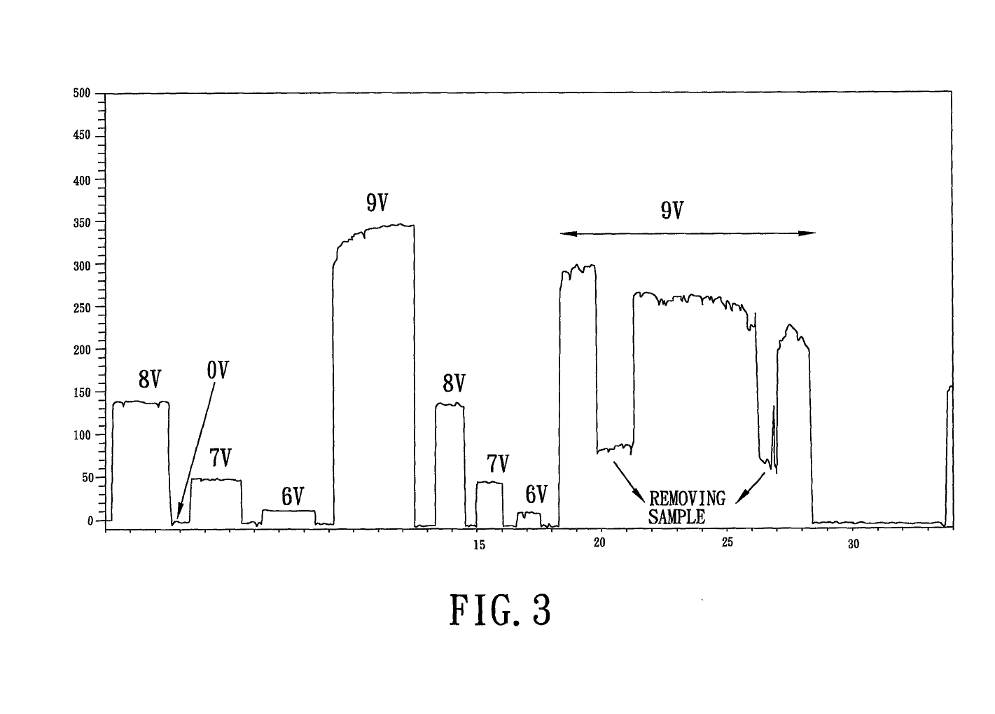

To ensure that the OEL layer can act as a light source for Fluorescent microsphere, the fluorescence emission phenomenon of Fluorescent microsphere excited by the OEL layer that is used as the light source is studied, and the results are shown in FIG. 3. The right side of the figure shows the fluorescence emission phenomenon of Fluorescent microsphere tested under an operating voltage of 9V, in which the two arrows shown on the right side of the figure indicate the removal of the dye. As can be seen from FIG. 3, a simple fluorescence of Fluorescent microsphere is generated by the excited light from the OEL layer.

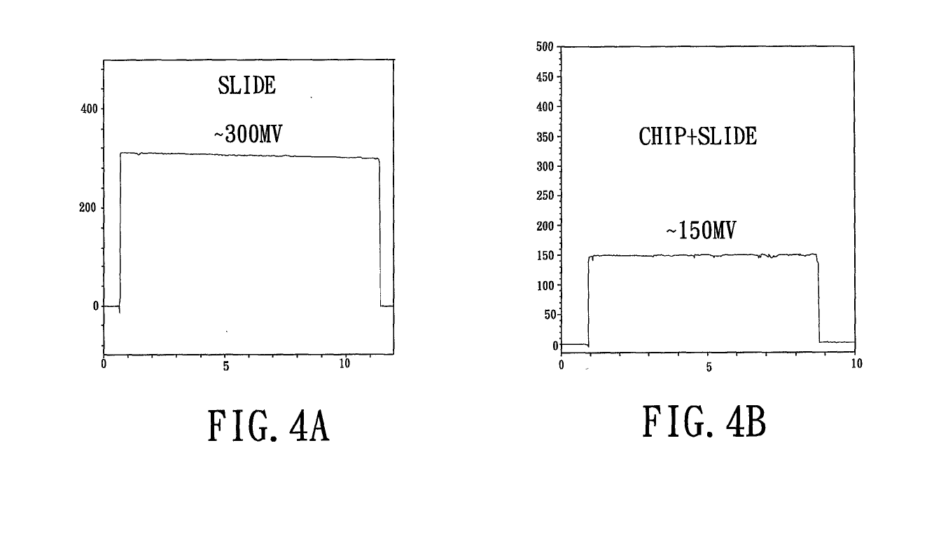

The Fluorescence stability of Fluorescent Microsphere is also tested, and the results are shown in FIGS. 4A and 4B. In FIG. 4A, a slide carrying the dye is placed on the OEL layer which is positioned on the stage of the microscope, and signal detection is performed under an operating voltage of 9V for 10 minutes. The microchip component is then positioned between the slide and the OEL layer and detection is conducted again for 10 minutes. The results are shown in FIG. 4B.

From the above experiments, it is concluded that the OEL layer works well as a light source for the microchip component.

It is also possible for the OEL layer to act as a heating source, if the OEL light is selected to be located near the IR region so as to generate the required heat for biochemical reactions, such as PCR or enzymatic digestions.

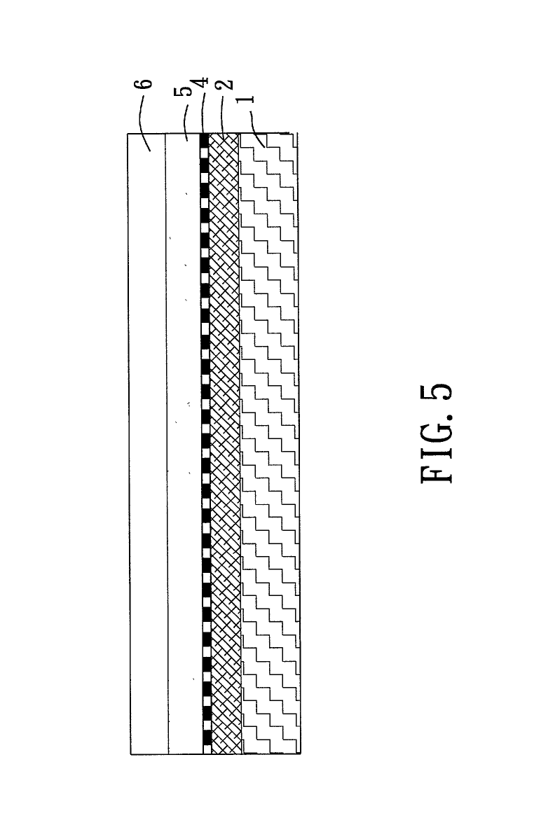

To increase the detection efficiency, the OEL-based biochip may be manufactured to have the structure as shown in FIG. 5, in which a second embodiment according to this invention comprises an OEL-emitting member 1, a microchip component 2, a pinhole layer 4, an emission filter 5 and a photosensor 6, which are integrally microfabricated in sequence.

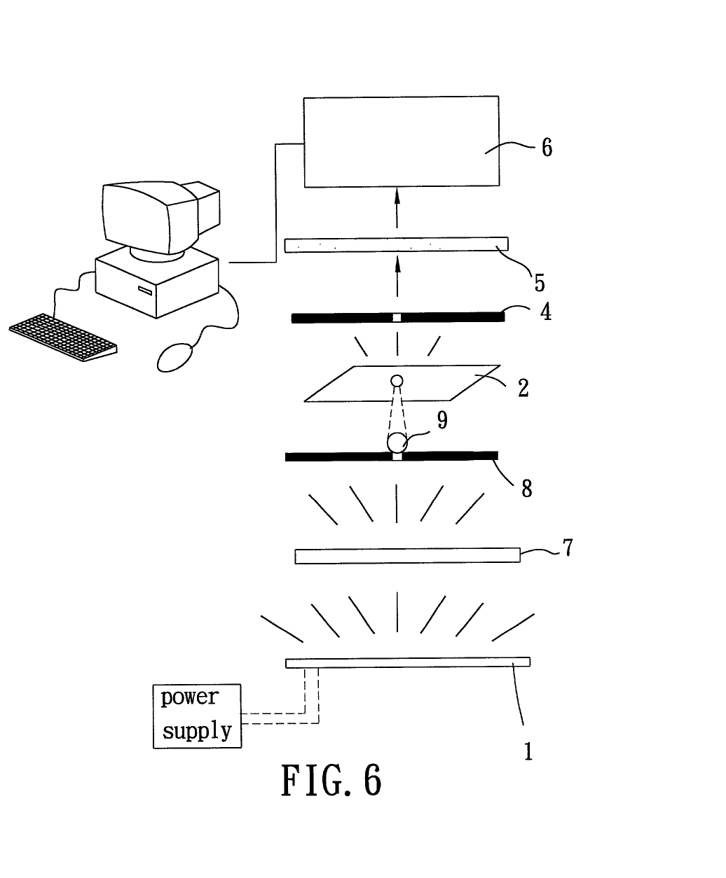

FIG. 6 shows a third embodiment according to this invention, which is constructed to comprise, in sequence, an OEL-emitting member 1, an excitation filter 7, a pinhole layer 8 and a ball lens 9, a microchip component 2, a pinhole layer 4, an emission filter 5, and a photosensor 6 such as a PMT or a photodiode or a CCD.

Preferably, the photosensor is connected to a computer for data processing and display.

Preferably, the aforesaid structural components of the third embodiment are integrally microfabricated to form a one-piece device.

All patents and literature references cited in the present specification are hereby incorporated by reference in their entirety. In case of conflict, the present description, including definitions, will prevail.

While the invention has been described with reference to the above specific embodiments, it is apparent that numerous modifications and variations can be made without departing from the scope and spirit of this invention. It is therefore intended that this invention be limited only as indicated by the appended claims.

We claim:

1. An organic electroluminescence (OEL)-based biochip, comprising:
a sheet member incorporating an OEL layer, and
a first microchip component mounted on one side of the sheet member to perform a predetermined application which is selected from a group that includes gene expression analysis, protein immunoassays, drug screening and cell-based assays and which optionally involves a biological system,
said OEL layer acting as one of a light source and a heating source for the first microchip component, or inducing photocurrent generated from an electrochemical reaction occurring in the biological system involved in the application of the first microchip component.

2. The OEL-based biochip according to claim 1, wherein the sheet member and the first microchip component are integrally microfabricated to form a one-piece device.

3. The OEL-based biochip according to claim 1, further comprising means superposed on the first microchip component for spectrally collecting fluorescence signal or transparent light emitted from the OEL layer and passing through the first microchip component.

4. The OEL-based biochip according to claim 3, wherein the spectral collecting means is manufactured as a separate component.

5. The OEL-based biochip according to claim 3, wherein the spectral collecting means is integrally microfabricated on the first microchip component.

6. The OEL-based biochip according to claim 3, wherein the spectral collecting means comprises a photosensor.

7. The OEL-based biochip according to claim 6, wherein the photosensor is one of a photomultiplier tube (PMT), a photodiode, and a charge-coupled device (CCD).

8. The OEL-based biochip according to claim 6, wherein the photosensor is connected to a computer for data processing and display.

9. The OEL-based biochip according to claim 3, further comprising first filtering means positioned between the first microchip component and the spectral collecting means for spectrally filtering fluorescence signal or transparent light emitted from the OEL layer and passing through the first microchip component.

10. The OEL-based biochip according to claim 9, wherein the first filtering means comprises an optical lens.

11. The OEL-based biochip according to claim 10, wherein the optical lens is an emission filter.

12. The OEL-based biochip according to claim 10, wherein the first filtering means is positioned on the first microchip component by forming a filter coating on the first microchip component.

13. The OEL-based biochip according to claim 9, wherein the first filtering means comprises a pinhole layer and an emission filter superposed on the pinhole layer.

14. The OEL-based biochip according to claim 3, further comprising second filtering means positioned between the sheet member and the first microchip component for spectrally filtering fluorescence signal or transparent light emitted from the OEL layer.

15. The OEL-based biochip according to claim 14, wherein the second filtering means comprises an excitation filter.

16. The OEL-based biochip according to claim 14, wherein the second filtering means is positioned on the first microchip component by forming a filter coating on the sheet member.

17. The OEL-based biochip according to claim 14, further comprising a ball lens and a pinhole layer positioned between the second filtering means and the first microchip component for focusing the fluorescence signal or transparent light emitted from the OEL layer and passing through the second filtering means.

18. The OEL-based biochip according to claim 1, wherein the first microchip component is manufactured in the form of one of an array type device and a microfluidic system.

19. The OEL-based biochip according to claim 1, wherein the first microchip component is immobilized with biological molecules, selected from a group that includes DNA, RNA, proteins, lipids, carbohydrates and hormones, onto a substrate.

20. The OEL-based biochip according to claim 19, wherein the application of the first microchip component is detected by a dye tagged onto the biological molecules immobilized on the first microchip component, and wherein said dye can be excited by absorbing the OEL emission from the OEL layer such that upon use, the dye generates a detectable emission wavelength, the peak of which is sufficiently apart from the peak of the excitation wavelength of the dye and the peak of the OEL emission.

21. The OEL-based biochip according to claim 20, wherein the peak of excitation wavelength and the peak of emission wavelength of the dye are apart from each other by at least 25 nm.

22. The OEL-based biochip according to claim 20, wherein the peak of excitation wavelength and the peak of emission wavelength of the dye are apart from each other by about 25 nm.

23. The OEL-based biochip according to claim 20, wherein the OEL layer is composed of organic electroluminescent materials so that the OEL layer emits an OEL emission selected from an emission of green luminescent wavelength preferably in the range of 500-550 nm, an emission of red luminescent wavelength preferably in the range of 590-640 nm, an emission of blue luminescent wavelength preferably in the range of 435-485 nm, and a full color emission.

24. The OEL-based biochip according to claim 23, wherein the OEL layer emits an OEL emission of green luminescent wavelength preferably in the range of 500-550 nm, and wherein the dye is one selected from TransFluoSpheres® carboxylate-modified microspheres, 7-aminoactinomycin D (7-ADD), Nile Red, and Propidium Iodine.

25. The OEL-based biochip according to claim 23, wherein the OEL layer emits an OEL emission of red luminescent wavelength preferably in the range of 590-640 nm, and wherein the dye is one selected from Naphthofluorescein, 5- and 6-carboxynaphthofluoresceins, succinimidyl ester mixed siomers and transfluospheres fluorescent microspheres.

26. The OEL-based biochip according to claim 23, wherein the OEL layer emits an OEL emission of blue luminescent wavelength preferably in the range of 435-485 nm, and wherein the dye is one selected from NBD, 3-(4-carboxybenzoyl)quinoine-2-carboxaldehyde (CBQCA), 6-(N-(7-nitrobenz-2-oxa-1,3-diazol-4-yl)amino)hexanoic acid, naphthalene-2,3-dicarboxaldehyde (NDA), succinimidyl 6-(N-(7-nitrobenz-2-oxa-1,3-diazo-4-yl)amino)hexanote (NBD-X,SE) and ethidium monoazide bormide.

27. The OEL-based biochip according to claim 19, wherein the substrate of the first microchip component is one of glass, silica, quartz, acrylic, and polymeric materials such as polycarbonate (PC), polyethylene tetraphthalate glycol (PETG) and hydrophilic poly(methyl methacrlate) (PMMA).

28. The OEL-based biochip according to claim 27, wherein the substrate of the microchip component is PMMA.

29. The OEL-based biochip according to claim 1, wherein the sheet member is fabricated such that the OEL layer is formed on a flexible substrate.

30. The OEL-based biochip according to claim 29, wherein the flexible substrate is a plastic sheet.

31. The OEL-based biochip according to claim 1, wherein the sheet member is fabricated into a transparent OLED component.

32. The OEL-based biochip according to claim 31, further comprising a second microchip component mounted on the other side of the sheet member to perform a predetermined application selected from a group that includes gene expression analysis, protein immunoassays, drug screening, and cell-based assays.

33. An organic electroluminescence (OEL)-based biochip, comprising:
(a) a sheet member incorporating an OEL layer; and
(b) a composite laminate mounted on the surface of one side of the sheet member and comprising in series the following elements superposed one upon the other:
(1) first filtering means for filtering fluorescence signal or transparent light excited from the OEL layer;
(2) a ball lens and a pinhole layer for focusing the filtered, excited fluorescence signal or transparent light;
(3) a microchip component to perform a predetermined application which is selected from a group that includes gene expression analysis, protein immunoassays, drug screening and cell-based assays and which optionally involves a biological system;
(4) second filtering means superposed on the microchip component for filtering the fluorescence signal or transparent light emitted from the microchip component; and
(5) a photosensor for collecting the filtered, emitted fluorescence signal or transparent light;
said OEL layer acting as one of a light source and a heating source for the microchip component, or inducing photocurrent generated from an electrochemical reaction occurring in the biological system involved in the application of the microchip component.

34. The OEL-based biochip according to claim 33, wherein the photosensor is one of a PMT, a photodiode, and a charge-coupled device (CCD).

35. The OEL-based biochip according to claim 33, wherein the photosensor is connected to a computer for data processing and display.

36. The OEL-based biochip according to claim 33, wherein the components of the OEL-based biochip are integrally microfabricated to form a one-piece device.

37. The OEL-based biochip according to claim 33, wherein the microchip component is manufactured in the form of one of an array type device and a microfluidic system.

38. The OEL-based biochip according to claim 37, wherein the microchip component is immobilized with biological molecules, selected from a group that includes DNA, RNA, proteins, lipids, carbohydrates and hormones, onto a substrate.

39. The OEL-based biochip according to claim 38, wherein the application of the microchip component is detected by a dye tagged onto the biological molecules immobilized on the microchip component, and wherein said dye can be excited by absorbing the OEL emission from the OEL layer such that upon use, the dye generates a detectable emission wavelength, the peak of which is sufficiently apart from the peak of the excitation wavelength of the dye and the peak of the OEL emission.

40. The OEL-based biochip according to claim 39, wherein the peak of excitation wavelength and the peak of emission wavelength of the dye are apart from each other by at least 25 nm.

41. The OEL-based biochip according to claim 39, wherein the peak of excitation wavelength and the peak of emission wavelength of the dye are apart from each other by about 25 nm.

42. The OEL-based biochip according to claim 39, wherein the OEL layer is composed of organic electroluminescent materials so that the OEL layer emits an OEL emission selected from an emission of green luminescent wavelength preferably in the range of 500-550 nm, an emission of red luminescent wavelength preferably in the range of 590-640 nm, an emission of blue luminescent wavelength preferably in the range of 435-485 nm, and a full color emission.

43. The OEL-based biochip according to claim 42, wherein the OEL layer emits an OEL emission of green luminescent wavelength preferably in the range of 500-550 nm, and wherein the dye is one selected from TransFluoSpheres® carboxylate-modified microspheres, 7-aminoactinomycin D (7-ADD), Nile Red, and Propidium Iodine.

44. The OEL-based biochip according to claim 42, wherein the OEL layer emits an OEL emission of red luminescent wavelength preferably in the range of 590-640 nm, and wherein the dye is one selected from Naphthofluorescein, 5- and 6-carboxynaphthofluoresceins, succinimidyl ester mixed siomers and transfluospheres fluorescent microspheres.

45. The OEL-based biochip according to claim 42, wherein the OEL layer emits an OEL emission of blue luminescent wavelength preferably in the range of 435-485 nm, and wherein the dye is one selected from NBD, 3-(4-carboxybenzoyl)quinoine-2-carboxaldehyde (CBQCA), 6-(N-(7-nitrobenz-2-oxa-1,3-diazol-4-yl)amino)hexanoic acid, naphthalene-2,3-dicarboxaldehyde (NDA), succinimidyl 6-(N-(7-nitrobenz-2-oxa-1,3-diazo-4-yl)amino)hexanote (NBD-X,SE) and ethidium monoazide bormide.

46. The OEL-based biochip according to claim 38, wherein the substrate of the microchip component is one of glass, silica, quartz, acrylic, and polymeric materials such as polycarbonate (PC), polyethylene tetraphthalate glycol (PETG) and hydrophilic poly(methyl methacrlate) (PMMA).

47. The OEL-based biochip according to claim 46, wherein the substrate of the microchip component is PMMA.

48. The OEL-based biochip according to claim 33, wherein the sheet member is fabricated such that the OEL layer is formed on a flexible substrate.

49. The OEL-based biochip according to claim 48, wherein the flexible substrate is a plastic sheet.

50. The OEL-based biochip according to claim 33, wherein the sheet member is fabricated into a transparent OLED component.

51. The OEL-based biochip according to claim 50, wherein a second composite laminate with the same construction as that of the first composite laminate is mounted on the other side of the sheet member.
